(19) United States
(12) Patent Application Publication
(10) Pub. No.: US 2014/0250009 A1
(43) Pub. Date: Sep. 4, 2014

(54) Debit/Credit Card Fraud Prevention Software and Smart Phone Application System and Process

(71) Applicant: Daniel Edward Carlson, Quinlan, TX (US)

(72) Inventor: Daniel Edward Carlson, Quinlan, TX (US)

(21) Appl. No.: 13/890,266

(22) Filed: May 9, 2013

(51) Int. Cl. G06Q 20/40

(52) U.S. Cl. CPC G06Q 20/40
USPC 705/44

(57) ABSTRACT

The present invention is a bank card fraud prevention system comprising a smart phone application and fraud prevention software placed within financial institutions that provide the subscriber the option to approve or decline a bank card transaction in real time based on a comparison between the user's smart phone geographical location at the time of the pending bank card transaction and the location of the purchase. The subscriber will have the ability to either immediately approve or decline the pending transaction by responding to the alert on the subscriber's present invention's smart phone application. The present invention smart phone application and fraud prevention software placed is within the subscriber's financial institution will further allow the subscriber to block all bank card transactions until the subscriber and the financial institution can determine if the subscriber's account has been compromised.

### CLAIM TO PRIORITY

This application claims priority to provisional application 61/644,962, filed May 9, 2012.

### TECHNICAL FIELD OF THE INVENTION

The present invention relates generally to smart phone (I-Phone/Android) applications and accompanying software placed within banks to eliminate or greatly reduce the possibilities of debit, automated teller machine (ATM), and credit card fraud.

### BACKGROUND OF THE INVENTION

Billions of dollars are lost each year as a result of bank card fraud, which includes misuse of debit, credit, and ATM cards as a fraudulent source of funds in commercial transactions. The purpose may be to obtain goods without paying, or to obtain unauthorized funds from an account. Bank card fraud is also a gateway to identity theft.

Banks use many methods to detect fraudulent use, including the use of limits on charge amounts, examination of charge patterns, and restrictions of geographic boundaries without validation. Account holders, also known as subscribers, are often frustrated with clumsy methods that simply shut off account access without providing feedback for valid charges.

Currently there is no system in place where a banking card holder can monitor and control each transaction of a bank card in real time based on card-holder location, allowing far-away charges when they are valid, but immediately shutting down card use when appropriate.

### SUMMARY OF THE INVENTION

An object of this present invention is to immediately alert each subscriber of pending debit card, ATM card, or credit card transactions outside of the subscriber's geographical location.

An additional object of the present invention is the ability of the subscriber to immediately respond to each pending debit card, ATM card, or credit card transaction by either declining or approving the pending transaction.

The present invention is a novel and unique process where the subscriber will have the ability to monitor and control each financial transaction relating to his credit card, debit card, or ATM card in real time, thus preventing the risk of credit card fraud and identity theft.

In this specification, the term “bank card” refers to credit cards, ATM cards, debit cards, gift cards, and all flavors of similar devices, including the payment of goods and services in which a buyer provides an account number and verification data to a seller, who uses that information to obtain the agreed payment from the third party who provides the account and any associated card.

Each subscriber enrolls into the service via logging into a secure web site and providing information pertaining to his credit card, debit card, or ATM card and financial institution. Each subscriber will choose a username and password to access and monitor their account. Each subscriber will then download a provided software client application that is appropriate to his smart phone. (Currently, the smart phone market is dominated by Android and iPhone operating systems, but the invention can be set on any programmable smart phone.

Once the present invention is downloaded, subscribers set personal preferences and parameters regarding their accounts. These personal preferences include establishing dollar amount limits for the present invention to notify them when a credit card debit card, or ATM card transaction is pending.

Once subscribers have completed the enrollment and set up process of the present invention, their financial institution is notified, at which time the present invention will notify them when a credit card, debit card, or ATM card transaction is pending.

The pending invention will notify the subscriber through the present invention application on the subscriber's smart phone with an alert message. The subscriber will have a set time to either approve the pending credit card transaction. The default time to respond is thirty seconds, but this time period can optionally be managed by the user or the financial institution, as they determine.

If the present invention does not receive a response from the subscriber within the allotted time, the present invention will then automatically decline the pending bank card transaction, and then notify the subscriber's financial institution of a possible instance of credit card fraud.

It is a feature and advantage of this present invention that the subscribers' smart phone geographic location software be integrated into the application. Each time a subscriber makes a purchase using his subscribed bank card, the present invention will locate the subscriber by the location of his phone. If the software verifies that the phone and the location of the purchase are the same, the present invention will not send an automatic pending transaction to the subscriber's smart phone for immediate approval, but instead automatically approve the pending bank card transaction (assuming the transaction does not violate some other criteria that is monitored by the bank or another fraud-prevention system).

The phone can be located by GPS, or any other approach, such as logging into a local wireless LAN, and gleaning the verification location from a server.

If a pending bank card transaction is being made at a location different than the subscribers current location, the present invention will recognize the disparity and send and automatic alert to the subscribers phone for immediate approval. If the subscriber determines that the pending credit card, debit card, or ATM card transaction is un-authorized, the subscriber will then have the ability to decline the pending transaction thus preventing the loss of any monies to the subscriber and financial institution. The present invention will then send a decline transaction message to the vendor. The subscriber will then have the ability to immediately notify their financial institution using the present invention of a possible instance of credit card fraud.

The present invention will be placed within each financial institution and by doing so, will add an additional layer of credit card fraud prevention for the financial institution and subscriber. It is this present invention that will monitor each subscribers credit card, debit card, or ATM card transactions, and, immediately alert the present invention application on the subscriber's smart phone each time a credit card, debit card, or ATM card transaction is pending outside of the subscribers geographical location.

The present invention provides a unique system that will immediately alert each subscriber anytime there is an individual credit card, debit card, or ATM card transaction pending. Utilizing the present invention will be instrumental in reducing fraudulent activities while reducing the likelihood of unauthorized credit card, debit card, or ATM card usage.

Other features and advantages of the present disclosure will be apparent to those of ordinary skill in the art upon reference to the following detailed description taken in conjunction with the accompanying drawings.

### BRIEF DESCRIPTION OF THE DRAWINGS

For a better understanding of the disclosure, and to show by way of example how the same may be carried into effect, reference is now made to the detailed description along with the accompanying figures in which corresponding numerals in the different figures refer to corresponding parts and in which:

FIG. 1 is a conceptual flow diagram which depicts the system of the present invention.

FIG. 2 is a depiction of the present invention's alert notification of a pending card transaction as received on the subscriber's smart phone.

FIG. 3 is a depiction of the present invention's detailed transaction notice as received on the subscriber's smart phone.

FIG. 4 is a depiction of the present invention's “block transaction” option screen as received on the subscriber's smart phone.

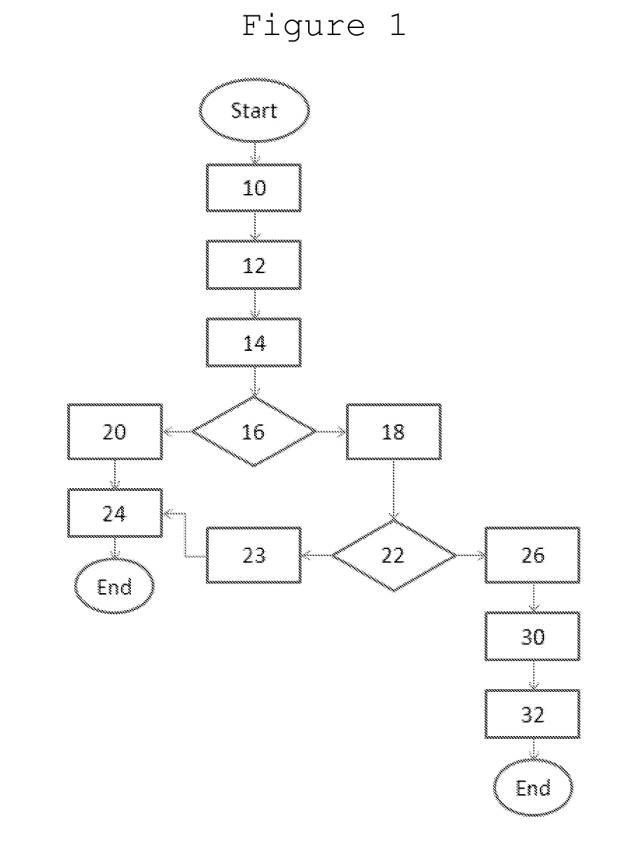

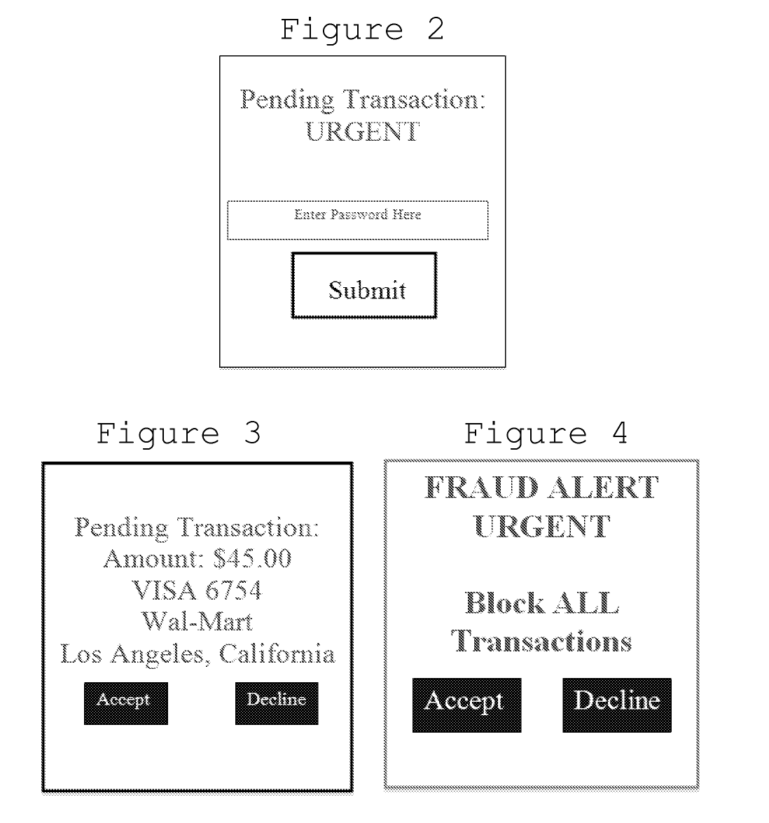

### DETAILED DESCRIPTION OF THE INVENTION

While the making and using of various embodiments of the present disclosure are discussed in detail below, it should be appreciated that the present disclosure provides many applicable inventive concepts, which can be embodied in a wide variety of specific contexts.

The figures provide a conceptual diagram of the process flow, as follows:
Step 10—A subscriber with the invention's smart phone application installed approaches a vendor.
Step 12—A vendor swipes the subscriber's bank card data for purchase, which sends a request to the financial institution associated with the bank card.
Step 14—The present invention's fraud prevention software placed within the financial institution receives the request for funds from the vendor, along with the vendor's location, and provides notice of the pending transaction back to the subscriber's smart phone which has the pending invention's application installed.
Step 16—The smart phone's application receives the transaction details from the financial institution, which includes location data for the vendor. The smart phone application compares the location vendor information and the location of the smart phone itself.
Step 20—If the application recognizes that the two locations are within a preset distance, the pending invention's application will automatically return an approval notification notice to the pending invention's fraud prevention software located within the subscriber's financial institution.
Step 24—When the bank receives the approval from the subscriber's smart phone, it then approves the pending transaction to the vendor.
Step 18—When the present invention's application does not recognize that the subscriber is within the geographical location of the vendor processing the subscriber's credit card for a purchase, then the present invention's application will immediately send an alert to the subscriber's smart phone.
Step 22—For pending transactions that are requested by vendors who are not co-located, the subscriber receives a notification, at which time the subscriber enters his password to access the present invention's application. The application then reveals the pending transaction details, which includes particulars such as vendor, amount, and location. The subscriber will then have 30 seconds to either accept or decline the pending transaction.
Step 26—If after 30 seconds the subscriber fails to either accept or decline the pending transaction, the present invention's application will notify the present inventions fraud prevention software to decline the pending transaction at the vendor location.
Step 30—Should the subscriber not recognize the pending transaction, or feel as though their credit card has been compromised, then the subscriber can immediately decline the pending transaction using the present invention's smart phone application which will alert the present inventions fraud prevention software within the subscriber's financial institution that the subscriber declined the pending credit card transaction. The present invention's fraud prevention software located within the financial institution will immediately send a declined notice to the vendor attempting to process the subscriber's credit card. The present invention's fraud prevention software located within the financial institution (FIG. 12) will then notify the subscribers financial institution of possible credit card fraud involving the subscribers credit card.
Step 32—The present invention will also provide the subscriber the ability to immediately block all further transactions involving their credit card until they and their financial institution can determine of their credit card or personal information has been compromised.

### EXAMPLES

### Example #1

Mark and Tiffany decide to go out for dinner on a Friday night. They drive into town to the Red Lobster Restaurant where they both enjoy a nice dinner together. The waiter brings Mark the bill for the meal which totals $64.87. Mark provides his credit card to the waiter in payment for the dinner. The waiter processes Mark's credit card for the total amount $64.87 via a point-of-sale system or credit card processing terminal. The pending transaction leaves the Red Lobster Restaurant en route to Mark's financial institution for approval. Before the pending Red Lobster Restaurant transaction for $64.87 reaches Mark's financial institution for approval, the present invention's fraud prevention software sends an alert to Mark's smart phone present invention's application. Mark's previously downloaded present invention's smart phone application will immediately recognize that Mark (the card holder) is within the geographical location of the pending transaction (Red Lobster Restaurant). The present invention's smart phone application will immediately return an approved status to the present invention's software within Mark's financial institution, which in turn sends the pending Red Lobster Restaurant transaction on to Mark's financial institution for final approval.

### Example #2

It is 4:00 AM and Jack is asleep at his house in Dallas, Tex. The waiter who Jack provided his credit card to earlier in the day has sold the credit card information to a third party, who is now using it in Los Angeles to purchase $354.00 worth of items from a local retailer. Jack's credit card is entered at the Los Angeles retailers location and the pending $354.00 transaction is en route to Jack's financial institution. Before the pending transaction gets to Jack's account, the present invention fraud prevention software located within the financial institution sends an alert to Jack's previously downloaded present invention's smart phone application. The present invention's smart phone application recognizes that Jack is not within the geographical location of the pending $354.00 credit card transaction. The present invention's application will immediately alert Jack's smart phone of the pending transaction. Jack awakens at the alert tone on the present invention's application and discovers that there is a pending transaction for $354.00 in Los Angeles, Calif. Jack immediately declines the pending transaction at which time the present invention's smart phone application will alert the present invention's software located within Jack's financial institution that Jack declined the transaction. The present invention's software located within Jack's financial institution will immediately send the vendor location in Los Angeles, Calif. a decline transaction notice. The present invention's software within Jack's financial institution will then immediately notify Jack's financial institution that Jack's credit card has possibly been compromised. Also, Jack chooses to utilize the “Block ALL Transactions” option on the present invention's smart phone application until he can effectively determine if his credit card information has been compromised or stolen. The present invention's fraud prevention software located within Jack's financial institution will then prevent any additional credit card transactions from being processed with Jack's subscribed credit card. Once Jack's possible credit card fraud issue is resolved, Jack can access the present invention's smart phone application and cancel the “Block ALL Transactions” status.

Similar embellishments, and various combinations thereof, are all comprehended by the present disclosure. The embodiment as described herein is presented for purposes of illustration and explanation only. The specific compositions, configurations, orientations and operations of various features, portions and options may be provided in a number of ways in accordance with the present disclosure.

As an example of the manner in which the general teachings herein may be specifically employed, while the above disclosure has been presented in connection with a 30-second reaction period to approve or deny a transaction. However, those of skill in the art will recognize that the teachings of the present disclosure may be employed with varying approval periods.

As another example, the system may treat international charges more strictly, or allow a user to permanently approve a particular regular payment, eliminating a tedious approval every month.

Yet another option is to allow a user to preemptively approve charges for a set period of time before approaching a vendor.

Thus, the embodiments and examples set forth herein are presented to best explain the present disclosure and its practical application and to thereby enable those skilled in the art to make and utilize the disclosure. As previously explained, those skilled in the art will recognize that the foregoing description and examples have been presented for the purpose of illustration and example only. The description as set forth is not intended to be exhaustive or to limit the disclosure to the precise form disclosed. Many modifications and variations are possible in light of the above teaching without departing from the spirit and scope of the following claims.

I claim:

1-13. (canceled)

14. A system for processing a bank card transaction, said system comprising:
an authorization server associated with a financial institution;
a remote subscriber software module associated with a subscriber, said subscriber software module including a location position system and in communication with said authorization server;
a vendor software module associated with a vendor, said vendor software module including position information and in communication with said authorization server;
said authorization server configured to conditionally authorize the bank card transaction based on real time distance between received location data from said subscriber software module and position data received from said vendor software module.

15. The system of claim 14 wherein said location position system comprises a global position system.

16. The system of claim 14 wherein said location position system comprises a wifi positioning system.

17. The system of claim 14 wherein said location position system comprises a network address lookup system.

18. The system of claim 14 wherein said location position system comprises a cell phone tower position information.

19. The system of claim 14 wherein said authorization server is configured to confirm the transaction where the distance is within a pre-set threshold.

20. The system of claim 14 wherein said authorization server is configured to automatically authorize the transaction where the distance is within a pre-set threshold.

21. The system of claim 14 wherein said subscriber software module is configured to display an alert where the distance is outside a pre-set threshold.

22. The system of claim 21 wherein said alert comprises an input for subscriber authorization of the bank card transaction.

23. The system of claim 21 wherein said input requires subscriber authorization of the bank card transaction within a pre-set time threshold.

24. The system of claim 21 wherein said input requires transaction detail confirmation input of the bank card transaction.

25. The system of claim 14 wherein the bank card transaction authorization is further conditioned on the transaction amount.

26. The system of claim 14 wherein further bank card transactions are declined upon a unauthorized transaction.

27. A method for processing a bank card transaction, said method comprising the steps of:
associated an authorization server with a financial institution;
providing remote subscriber software module associated with a subscriber in communication with said authorization server and having a location position system;
providing a vendor software module in communication with said authorization server and having vendor position information;
in response to an initiated bank card transaction, receiving location position data from said subscriber module, position data from said vendor module, and conditionally authorizing the bank card transaction based on real time distance between received location data from said subscriber software module and position data received from said vendor software module.

28. The method of claim 27 wherein said authorization server automatically authorizes the bank card transaction where the distance is within a pre-set threshold.

29. The method of claim 27 wherein said subscriber software module displays an alert where the distance is outside a pre-set threshold.

30. The method of claim 29 wherein said alert comprises an input for subscriber authorization of the bank card transaction.

31. The method of claim 29 wherein said input requires subscriber authorization of the bank card transaction within a pre-set time threshold.

32. The method of claim 29 wherein said input requires transaction detail confirmation input of the pending bank card transaction.

33. The method of claim 27 wherein the bank card transaction authorization is further conditioned on the transaction amount.

34. The method of claim 27 wherein the authorization server declines further bank card transactions upon a first unauthorized transaction.
